(19) United States
(12) Patent Application Publication
(10) Pub. No.: US 2026/0264230 A1
(43) Pub. Date: Sep. 10, 2026

(54) METHOD FOR CONTROLLING MOVEMENT OF ROBOT, ELECTRONIC DEVICE, AND COMPUTER READABLE STORAGE MEDIUM

(71) Applicant: ABB SCHWEIZ AG, Baden (CH)

(72) Inventors: Yizhi Chen, Shanghai (CN); Meng Xu, Shanghai (CN); Hao Gu, Shanghai (CN)

(21) Appl. No.: 19/664,964

(22) Filed: Apr. 30, 2026

Related U.S. Application Data
(63) Continuation of application No. PCT/CN2023/132356, filed on Nov. 17, 2023.

(51) Int. Cl. B25J 9/16

(52) U.S. Cl. CPC B25J 9/1628

(57) ABSTRACT

Embodiments of the present disclosure relate to controlling a movement of a robot. One of a first canvas and a second canvas is presented as an operating canvas on a screen of a terminal device. The first canvas is associated with at least one dimension of the three dimensions of a first coordinate system of the robot, and the second canvas is associated with the other one or more dimensions of the three dimensions. An input of a swipe on the operating canvas is received, and movement instruction for controlling the robot to move with reference to the first coordinate system is generated based on the swipe. In this way, a movement control mechanism requests intuitive gestures from users so that the user can operate on the operating canvas while observing the environment around the robot, thereby increasing operation safety of the robot.

### FIELD

Embodiments of the present disclosure generally relate to the field of robotics, and more particularly, to a method for controlling a movement of a robot, an electronic device, and a computer readable storage medium.

### BACKGROUND

Generally, industrial robots operate to complete industrial manufacturing operations under specific programs. In addition, when the robot is not operating according to a predefined program, the robot can be moved manually by a user with a console. The manual control may be referred to as jogging which is manually positioning or moving robots. Usually, jogging may be performed in a manual mode by a user with a teach pendant. The teach pendant may comprise a joystick and the user may push the joystick to different directions corresponding to the coordinate systems of a robot so that the robot may be moved with reference to different coordinate systems.

For example, the base coordinate system has its zero point in the base of the robot, which makes movements predictable for fixed mounted robots. It is therefore useful for jogging a robot from one position to another. In this case, when a user is standing in front of the robot and jog in the base coordinate system, in a normally configured robot system, pulling the joystick towards the user may move the robot along the X axis, while moving the joystick to the sides may move the robot along the Y axis. Further, twisting the joystick may move the robot along the Z axis.

### SUMMARY

In view of the foregoing problems, example embodiments of the present disclosure propose solutions for feature face identification at web side.

In a first aspect of the present disclosure, example embodiments of the present disclosure provide a method for controlling a movement of a robot. The method comprises presenting one of a first canvas and a second canvas as an operating canvas on a screen of a terminal device. In this case, the first canvas is associated with at least one dimension of the three dimensions of a first coordinate system of the robot and the second canvas is associated with other one or more dimensions of the three dimensions. The method further comprises receiving an input of a swipe on the operating canvas. The method further comprises generating a movement instruction for controlling the robot to move with reference to the first coordinate system based on the swipe.

In a second aspect, example embodiments of the present disclosure provide an electronic device. The electronic device comprises: at least one processor; and at least one memory storing instructions that, when executed by the at least one processor, cause the device to perform the method in accordance with the first aspect of the present disclosure.

In a third aspect, example embodiments of the present disclosure provide a computer readable storage medium storing instructions which, when executed by a computer, cause the computer to perform the method in accordance with the first aspect of the present disclosure.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 schematically illustrates a block diagram of a robot system in which example embodiments of the present disclosure can be implemented;

FIG. 2A schematically illustrates a flowchart of a method for controlling a movement of a robot in accordance with embodiments of the present disclosure;

FIG. 2B schematically illustrates a flowchart of a method for generating movement instructions in accordance with embodiments of the present disclosure;

FIG. 2C schematically illustrates a flowchart of a method for determining a movement direction in accordance with embodiments of the present disclosure;

FIGS. 3A-3C schematically illustrate schematic diagrams of example procedures for controlling the robot in a first coordinate system in accordance with some embodiments of the present disclosure;

FIGS. 4A-4D schematically illustrate schematic diagrams of example procedures for controlling the robot in a second coordinate system in accordance with some embodiments of the present disclosure;

FIG. 5 schematically illustrates a schematic diagram of an example procedure for updating the coordinate in the canvas in accordance with some further embodiments of the present disclosure;

FIG. 6 schematically illustrates a schematic diagram of an example procedure for switching to a third mode in accordance with some further embodiments of the present disclosure; and

FIG. 7 schematically illustrates a schematic diagram of an electronic device for implementing a method in accordance with embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the know circle of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, the robot can be manually jogged or moved by means of a provider-specific joystick. Nowadays, as personal terminal devices develop rapidly, more and more robot manufacturers choose to provide their applications on mobile devices including customized tablets and personal smartphones. In particular, moving the robot is one major functionality the applications always provide.

Conventionally, a user may tap corresponding User Interface (UI) elements on the touch screen to control the movements of the robot. However, as the UI elements can be placed in various positions on the screen and their corresponding responsive areas are limited, the user cannot press the correct elements without looking at the touch screen. As a result, the user might have to repeat a procedure for a few times to move the robot to a desired position. The procedure may include: look at the touch screen and find the correct element on the screen and press it; look up and observe the robot movement; stop pressing the element to stop the movement and look at the screen to decide what and where to press next. As it clearly shows, this procedure does not provide smooth user experience.

There are a few ways available on the market to mitigate this problem. One way is that the application provides a 3D virtual robot, which could synchronize the movement of the real robot on the screen. In this way, users can observe the robot movements on the screen when they are operating on the UI elements. However, the user still needs to observe the robot from time by time to guarantee the safety (i.e., no obstacle on the paths). Another way is to attach external equipment to the mobile device, which provides a console like a joystick. In this case, the user can simply use the joystick to control the robot while observing the robot all the time. However, the additional equipment would surely increase the cost.

In view of the above, a mechanism of robot movement controlling using personal terminal devices is provided. In the movement control mechanism, an operating canvas is presented on the screen of the terminal device. The operating canvas may include a first canvas corresponding to at least one dimension of the three dimension of a coordinate system of the robot and a second canvas corresponding to the other one or more dimension of the three dimension to cover all the dimension of a coordinate system. As a result, a simple swipe on the operating canvas can instruct the robot to move with reference to every dimension of the coordinate system. In this way, a complete moving function is provided which only requests intuitive gestures of the users so that the user can operate on the operating canvas while observing the environment around the robot thereby increasing operation safety of the robot.

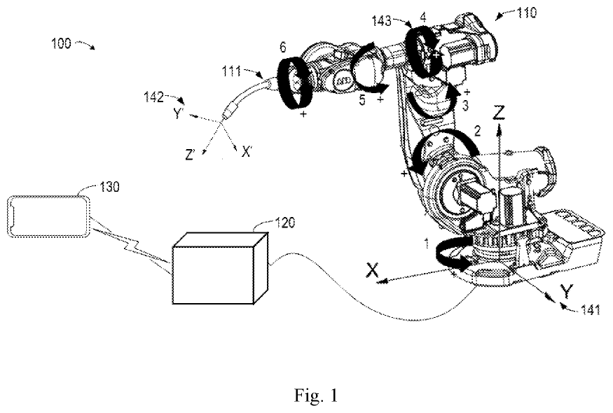

A framework in accordance with embodiments of the present disclosure will be described with reference to FIGS. 1 to 7. FIG. 1 schematically illustrates a block diagram of a robot system 100 in which example embodiments of the present disclosure can be implemented. As illustrated in FIG. 1, the robot system 100 includes a robot 110 which may be referred to as a six-axis robot or a manipulator. It should be appreciated that the movement control described herein generally relates to instructing a key point of the robot or a part of the robot to move with reference to pre-programmed coordinate system. On this basis, although one six-axis robot is illustrated here and may be taken as an example for describing the control mechanism hereinafter, the movement control mechanism in accordance with the embodiments of the disclosure can be applied to other types of robots regardless of the number of the axes, such as a four-axis robot or a seven-axis robot. In addition, the control mechanism may also be applied to consumer-grade robots.

The robot 110 may be used for welding operations and have a tool 111 attached to an end of the robot arm. The robot system 100 further includes a controller cabinet 120 for controlling the robot 110. The robot system 100 further includes a terminal device 130 communicatively coupled to the controller cabinet 120 wirelessly. In some alternative embodiments, the terminal device 130 may be communicatively coupled to the controller cabinet 120 with wire.

The terminal device 130 may generate movement instructions for controlling a movement of the robot 110 and transmit the movement instructions to the controller cabinet 120. The controller cabinet 120 may process the movement instructions and control the robot 110 to move according to the movement instructions.

As illustrated in FIG. 1, the robot system 100 further comprises a base coordinate system 141. The base coordinate system 141 is located at the base of the robot, i.e. the base coordinate system 141 has its zero point in the base of the robot. The base coordinate system 141 has three dimensions, including two horizontal dimensions, such as a dimension X and a dimension Y, and a vertical dimension, a dimension Z.

When moving the robot 110 with reference to the base coordinate system 141, a movement instruction may indicate a direction in the base coordinate system 141 and the tool 111 of the robot 110 may move an incremental distance in the indicated direction. For example, the movement instruction may indicate a direction in the horizontal plane X-Y, and the tool 111 may be moved in the horizontal plane X-Y without changing the height of the tool 111. Correspondingly, the movement instruction may indicate a direction along the vertical dimension Z, and the tool 111 may be moved only to change its height. Thus, the base coordinate system 141 makes the robot movements predictable for fixed mounted robots. It can be used intuitively for moving a robot from one position to another.

The robot system 100 further comprises a tool coordinate system 142. The tool coordinate system 142 defines the position of the tool 111 that the robot 110 uses when reaching the programmed targets. The tool coordinate system 142 has its zero position at the center point of the tool 111. It thereby defines the position and orientation of the tool 111, including a dimension X′, a dimension Y′ and a dimension Z′. The tool coordinate system 142 is often abbreviated TCPF (Tool Center Point Frame) and the center of the tool coordinate system is abbreviated TCP (Tool Center Point). It is the TCP that the robot 110 moves to the programmed positions, when executing programs. When moving the robot 110 with reference to the tool coordinate system 142, the orientation of the tool 111 will not be changed during the movement.

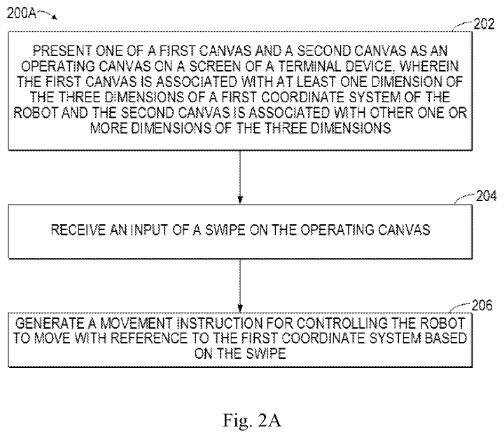

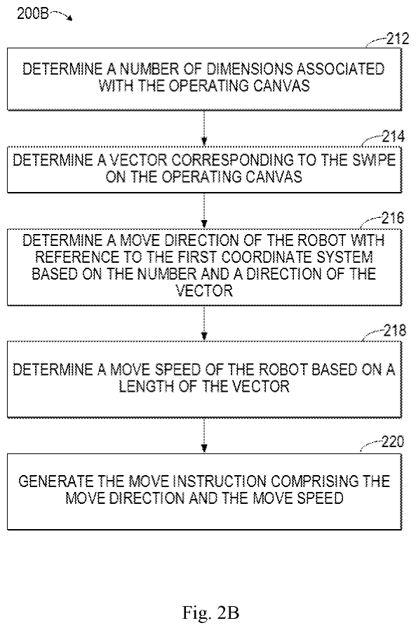

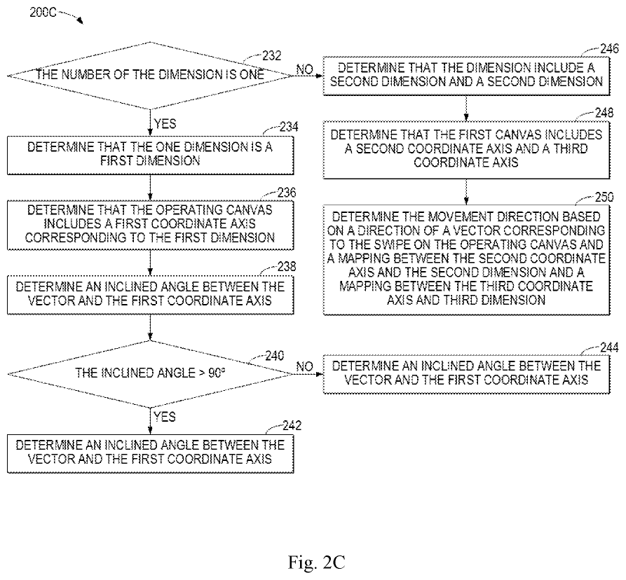

The robot system 100 further comprises an axis system 143. The axis system 143 comprises an axis 1, an axis 2, axis 3, axis 4, axis 5 and axis 6 respectively illustrated by six arrows and a rotation direction is marked with “+” for distinction. When moving the robot 120 with reference to the axis system 143, the movement instruction may indicate a target axis among the six axes and a rotation direction for the target axis. The movement instructions for different coordinate system may be generated by a user using a canvas presented on the terminal device 130. The instruction mechanism will be described in detail with reference to FIGS. 2A-2C.

FIG. 2A schematically illustrates a flowchart of a method 200A for controlling a movement of a robot in accordance with embodiments of the present disclosure. For discussion purpose, the method 200A will be described with reference to FIG. 1. For example, the method may be implemented by the terminal device 130 in FIG. 1.

At 202, one of a first canvas and a second canvas as an operating canvas is presented on a screen of a terminal device. In this case, the first canvas is associated with at least one dimension of the three dimensions of a first coordinate system of the robot and the second canvas is associated with other one or more dimensions of the three dimensions. For example, in the embodiment as illustrated in FIG. 1, the terminal device 130 may present one of a first canvas and a second canvas as an operating canvas on a screen of a terminal device. The first canvas may be associated with two dimensions of the first coordinate system, for example, the dimension X and the dimension Y of the base coordinate system 141 for receiving input instructions to cause the robot 110 to move in the X-Y plane. The second canvas may be associated with the dimension Z of the base coordinate system 141 for receiving input instructions to cause the robot 110 to move in the height direction.

At 204, an input of a swipe on the operating canvas is received. For example, in the embodiment as illustrated in FIG. 1, the terminal device 130 may receive an input of a swipe on the operating canvas from a user. In some example embodiments, the swipe may be input on the first canvas when the first canvas is presented as the operating canvas. Alternatively, the swipe may be input on the second canvas when the second canvas is presented as the operating canvas.

In some example embodiments, when an application for controlling the robot is activated on terminal device 130, the terminal device 130 may present or render the first canvas as a default operating canvas. If the user wants to operate on the second canvas, the user may input a trigger gesture. When the terminal device 130 receives input of a trigger gesture, the terminal device 130 may cover the first canvas to the second canvas. Then, the user may operate on the second canvas. In some example embodiments, the trigger gesture may be a drawing a circle on the screen or simultaneously touching multiple points on the screen, or touching a point in a specific region.

At 206, a movement instruction for controlling the robot to move with reference to the first coordinate system is generated based on the swipe. For example, in the embodiment as illustrated in FIG. 1, the terminal device 130 may generate the movement instruction for controlling the robot 110 to move with reference to the base coordinate system 141 based on the swipe input.

In the illustrated embodiment, the robot can be moved by swipe gestures performed on different canvas to cover all the possible movement directions. Since no UI elements are required, most part of the screen can be used as a canvas which is responsive for all the user touch inputs. As a result, the user may not need to look at the screen to operate which allows the user to operate robot using personal mobile devices while the user is staring at the robot thereby guarantee a safety around the vicinity of the robot and increasing user experience. In addition, no external equipment or console is required to be attached to the control cabinet resulting a reduction of the cost.

FIG. 2B schematically illustrates a flowchart of a method 200B for generating movement instructions in accordance with embodiments of the present disclosure. For discussion purpose, the method 200B will be described with reference to FIG. 1. For example, the method may be implemented by the terminal device 130 in FIG. 1.

At 212, the terminal device 130 determines a number of dimensions associated with the operating canvas. For example, when the operating canvas is the first canvas associated with two dimensions of the coordinate system of the robot, the number of the dimensions is two. When the operating canvas is the second canvas associated with the other one dimension of the coordinate system of the robot, the number of the dimensions is one.

At 214, the terminal device 130 determines a vector corresponding to the swipe on the operating canvas. For example, when a user swipes on the screen of the terminal device, the first point that the user touches may be identified by the terminal device 130 as a start point and the last point that the user touches before the user lifts his finger may be identified as an end point. Then, the vector may be determined by the terminal device 130 as a vector from the start point to the end point. The terminal device 130 may extract an inclined angle of the vector with reference to the coordinate axes of the operating canvas and a length of the vector for subsequent calculation.

At 216, the terminal device 130 determines a move direction of the robot with reference to the first coordinate system based on the number and a direction of the vector. The interpretation of the direction of the vector in a canvas associated with two dimension would be different from that in a canvas associated with a single dimension. In some example embodiments, in case that the operating canvas is associated with a single dimension, a movement direction is determined to indicate a positive direction of the single dimension or a negative direction of the single dimension. In some alternative embodiments, in case that the operating canvas is associated with two dimensions, a movement direction is determined to indicate a direction with reference to both dimensions.

At 218, the terminal device 130 determines a move speed of the robot based on a length of the vector. The terminal device 130 may store information about a ratio between the length of the vector and the move speed of robot and derive the move speed from the predefined ratio and the length of the vector. In some example embodiments, the ratio may be adjusted by the user.

At 220, the terminal device 130 generates the move instruction comprising the move direction and the move speed. After the move speed and the move direction is determined, a move instruction may be generated to instruct the controller cabinet 120 to control the robot 110 to move accordingly.

In the illustrated embodiments, by interpreting a length of the swipe on the canvas and relative directions between the swipe and the dimensions, only a gesture in form of a swipe can deliver various types of movement information for controlling the robot.

FIG. 2C schematically illustrates a flowchart of a method 200C for determining a movement direction in accordance with embodiments of the present disclosure. For discussion purpose, the method 200C will be described with reference to FIG. 1. For example, the method may be implemented by the terminal device 130 in FIG. 1.

At 232, the terminal device 130 determines whether the number of the dimensions is one. If the terminal device 130 determines that the number of the dimensions associated with the current operating canvas is one, method 200C proceeds to 234. At 234, the terminal device 130 determines that the one dimension is a first dimension. Correspondingly, at 236, the terminal device 130 determines that the operating canvas includes a first coordinate axis corresponding to the first dimension.

At 238, the terminal device 130 determines an inclined angle between the vector and the first coordinate axis. At 240, the terminal device 130 determines whether an inclined angle is smaller than 90 degrees. If the terminal device 130 determines that the inclined angle is smaller than 90 degrees, the method 200C proceeds to 242. At 242, the terminal device 130 determines the movement direction as a positive direction of the first dimension. Otherwise, if the terminal device 130 determines that the inclined angle is greater than 90 degrees, the method 200C proceeds to 244. At 244, the terminal device 130 determines a negative direction of the first dimension as the movement direction.

If the terminal device 130 determines that the number of the dimensions associated with the current operating canvas is not one, method 200C proceeds to 246. At 246, the terminal device 130 determines that the two dimensions comprises a second dimension and a third dimension. At 248, the terminal device 130 determines that the first canvas includes a second coordinate axis and a third coordinate axis. At 250, the terminal device 130 determines the movement direction based on a direction of a vector corresponding to the swipe on the operating canvas and a mapping between the second coordinate axis and the second dimension and a mapping between the third coordinate axis and the third dimension.

In the illustrated embodiment, the movement direction can be determined only based on the number of the dimension and vector direction, which requires very limited operations of a user thereby reducing the complexity of the robot control operation.

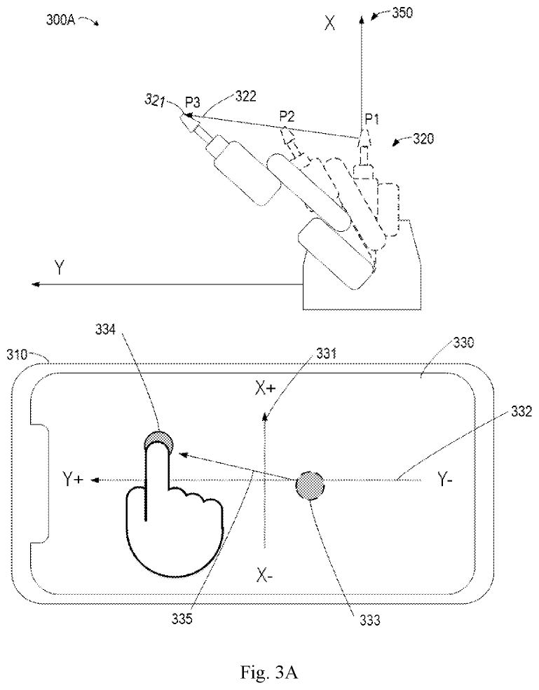

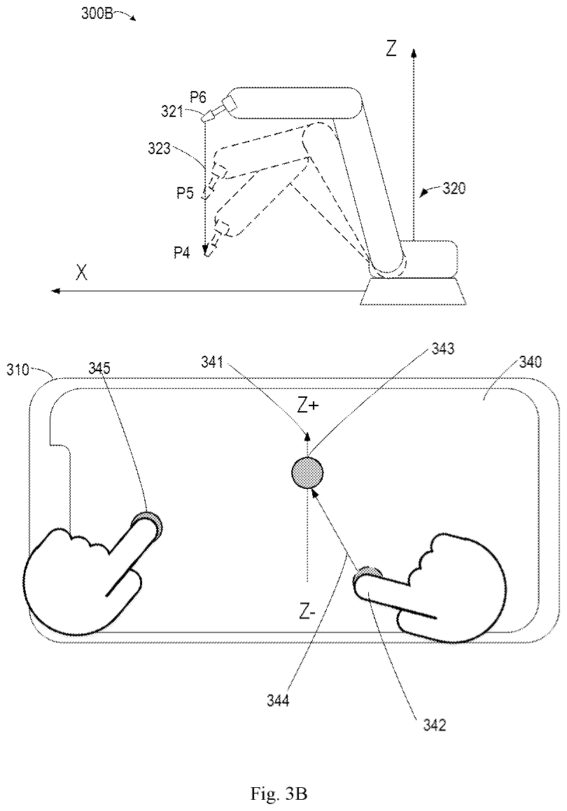

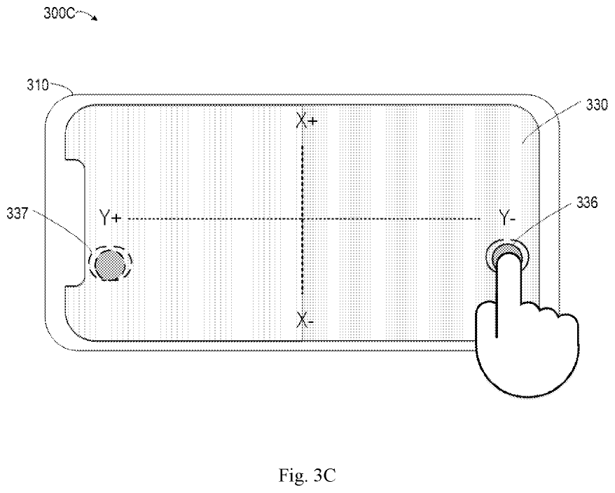

FIG. 3A schematically illustrates a schematic diagram of an example procedure 300A for controlling the robot in the first and second dimension of the first coordinate system in accordance with some embodiments of the present disclosure. The procedure 300A is implemented by a terminal device 310 and a robot 320 where the terminal device 310 generates movement instructions for controlling a movement of the robot 320 with reference to a base coordinate system 350 (also referred to as a first coordinate system). The terminal device 310 may be corresponding to the terminal device 130 as illustrated in FIG. 1 and the robot 320 may be corresponding to the robot 110 as illustrated in FIG. 1. The base coordinate system 350 may be corresponding to the base coordinate system 141 as illustrated in FIG. 1.

As illustrated in FIG. 3A, the terminal device 310 renders a first canvas 330 as the current operating canvas. The first canvas 330 includes a first coordinate axis 331 corresponding to a dimension X of the base coordinate system 350 and a second coordinate axis 332 corresponding to a dimension Y of the base coordinate system 350. A positive direction of the first coordinate axis 331 is marked with “X+” and a negative direction of the first coordinate axis 331 is marked with “X−”. Relatively, a positive direction of the second coordinate axis 332 is marked with “Y+” and a negative direction of the second coordinate axis 332 is marked with “Y−”.

When the user moves or jogs the robot 320, the user may use a finger to swipe on the first canvas 330 to move the tool 321 of the robot 320 according to the swipe input. At the terminal device side, the terminal device 310 receives the input of the swipe on the first canvas 330. When the finger touches a first point 342 on the first canvas 330, the terminal device 310 identifies an input of touch on the first point 342. Then, the finger continues to move on the first canvas 330 to a second point 343 and stops moving. The terminal device 310 identifies the input of the swipe as a vector 344 from a start point, i.e. the first point 342 to an end point, i.e. the second point 343.

After the vector 344 is determined, the terminal device 310 converts the length of the vector 344 to a move speed for example according to a predefined ratio. In the meantime, the terminal device 310 determines the direction of the vector with reference to the first coordinate axis 331 and the second coordinate axis 332, i.e. a two-dimension plane of the first canvas and maps the vector into the base coordinate system 350 of the robot 320. As a result, the direction of the mapped vector is determined to be a movement direction. With the obtained speed and direction information, the terminal device 310 generates a movement instruction. The terminal device 310 may transmit the movement instruction to a robot controller to cause the robot 320 to move.

In the illustrated embodiment, one movement instruction will cause the robot 320 to move an incremental distance in the sense of “jogging”. During moving or jogging the robot 320, the robot 320 moves from a start position P1 to a position P2 in the direction and at a move speed indicated by the movement instruction. The distance between the position P1 and the position P2 equals the incremental distance and may be referred to as a move increment. In the illustrated embodiment, the user continues to touch the second point 334 to indicate a consecutive movement. When the robot 320 reaches the position P2, a new movement instruction will be generated by the terminal device 310 and sent to the robot controller such that the robot 320 is moved to the end position P3 continuously or after a little pause. At this point, the user may determine that the robot 310 is moved in place and lift the finger up. As a result, the tool 321 of the robot 320 stops to move. The path 322 from the position P1 to the position P3 corresponds to the vector 335.

In the illustrated embodiment, only one swipe can define a movement direction and speed of the robot as long as a number of the movement. In this way, the user can intuitively perform the operation without looking down at the screen.

FIG. 3B schematically illustrates a schematic diagram of an example procedure 300B for controlling the robot 320 in the third dimension in the first coordinate system in accordance with some embodiments of the present disclosure. When the user moves or jogs the robot 320 in the Z dimension in addition to the X and Y dimension, the user need to operate the terminal device 310 to change the first canvas 330 to a second canvas 340 as the operating canvas by an input of a trigger gesture. In the illustrated embodiment, the user uses one finger to touch one point on the first canvas 310 while uses another finger to touch another point on the canvas. The terminal device 310 may convert the first canvas 330 to the second canvas 340 upon receiving the input of the touch on the second point. As a result, one finger of the user touches the first point 345 on the second canvas 340 and the other finger touches the second point 342 on the second canvas 340.

As illustrated in FIG. 3B, the terminal device 310 renders a second canvas 340 as the current operating canvas after the trigger input of simultaneously touching two points on the screen. The second canvas 340 includes only one third coordinate axis 341 corresponding to a dimension Z of the base coordinate system 350. A positive direction of the third coordinate axis 341 is marked with “Z+” and a negative direction of the third coordinate axis 341 is marked with “Z−”.

After the user touches the two points on the screen with two fingers and the second canvas 340 is presented, the user continues to use one of the two fingers on the second canvas 340 to swipe on the second canvas 340, in order to move the tool 321 of the robot 320 according to the swipe input. As illustrated, the user moves the finger on the second point 342 to a third point 343. At the terminal device side, the terminal device 310 receives the input of the swipe on the second canvas 340 and identifies the input of the swipe as a vector 344 from a start point, i.e. the second point 342 to an end point, i.e. the third point 343 on the second canvas 340.

After the vector 344 is determined, the terminal device 310 converts the length of the vector 344 to a move speed according to a predefined ratio. In the meantime, the terminal device 310 determines the direction of the vector with reference to the third coordinate axis 341. Since only one dimension is involved, the terminal device 310 may determine the move direction from a positive direction of the dimension Z and a negative direction of the dimension Z without mapping the direction of the vector 344 to the base coordinate system 350. In this case, the terminal device 310 calculates an inclined angel between the vector 344 and the third coordinate axis 341. The third coordinate axis 341 may be viewed as vector orientated to from the negative direction to the positive direction. The terminal device 310 further determines that the inclined angel between the vector 344 and the third coordinate axis 341 is smaller than 90 degrees which means that the vector 344 generally points towards a positive direction of the third coordinate axis 341. The terminal device 310 determines the positive direction of the dissension Z of the base coordinate system 350 as the movement direction in the movement instruction. With the obtained speed and direction information, the terminal device 310 generates the movement instruction. The terminal device 310 may transmit the movement instruction to a robot controller to cause the robot 320 to move.

During moving or jogging the robot 320, the robot 320 moves from a start position P4 to a position P5 in the direction and at the move speed indicated by the movement instruction. The distance between the position P4 and the position P5 equals the incremental distance which may be same or not the same with the incremental distance as illustrated in FIG. 3A. In the illustrated embodiment, the user continues to touch the third point 343 to indicate a consecutive movement. When the robot 320 reaches the position P5 during moving in the positive direction of the Z dimension, a new movement instruction will be generated by the terminal device 310 and sent to the robot controller such that the robot 320 is moved to the end position P6. At this point, the user may determine that the robot 310 is moved in place and lift his finger up. As a result, the tool 321 of the robot 320 stops to move. The path 323 from the position P4 to the position P6 is vertical with reference to the base coordinate system 350.

In this embodiment, a second canvas is provided for moving the robot in a third dimension. In this way, a natural deficiency that a 2-dimensional canvas may only define two directions for two dimensions can be implemented by providing an additional canvas which in turn can be easily called out.

FIG. 3C schematically illustrates a schematic diagram of an example procedure 300C for changing the incremental distance in accordance with some embodiments of the present disclosure. As discussed above, the user may change the incremental distance for each movement instruction. For example, when the user observes the movement of the robot 320 during jogging, the user may determine that the incremental distance is too large and decrease the incremental distance. Relatively, when the user determines that the incremental distance is too small, the user may increase the incremental distance. In these cases, the user may use an increment change mechanism.

As illustrated in FIG. 3C, the terminal device 310 renders the first canvas 330 as the operating canvas. The first canvas 330 is divided into two parts including a Y+ part at left and a Y− part on the right. The Y+ part may be from the central line to the left edge of the firs canvas 330 and the Y-part may be from the central line to the right edge of the firs canvas 330. When the user changes the incremental distance, the user may use only one finger to touch a point on the Y+ part or the Y− part.

As illustrated, when the user wants to increase the incremental distance, the user may touch a point 336 in the Y− part without moving for a predefined time period. At the terminal device side, the input of continuously touching one point in the Y− part of the first canvas 340 is identified by the terminal device 340 as increasing the incremental distance by a predefined length. In some example embodiment, once the incremental distance is increased by the predefined length, the terminal device 310 may signal the user about completion of the increase for example by presenting a sign, vibrating or outputting a sound.

Alternatively, when the user wants to decrease the incremental distance, the user may touch a point 337 in the Y+ part without moving for a predefined time period. At the terminal device side, the input of continuously touching one point on Y+ part of the first canvas 340 is identified by the terminal device 340 as decreasing the incremental distance by a predefined length. In this way, the incremental distance can be conveniently changed during operation.

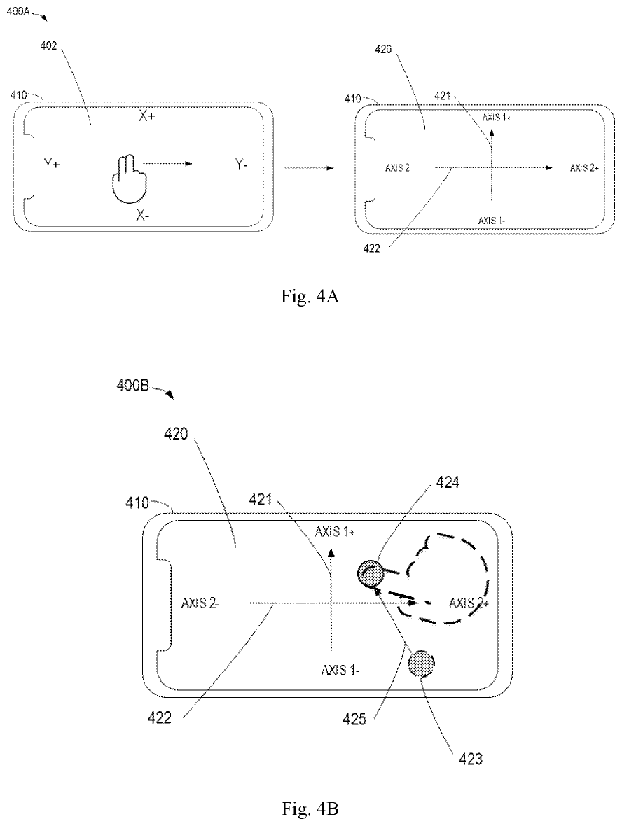

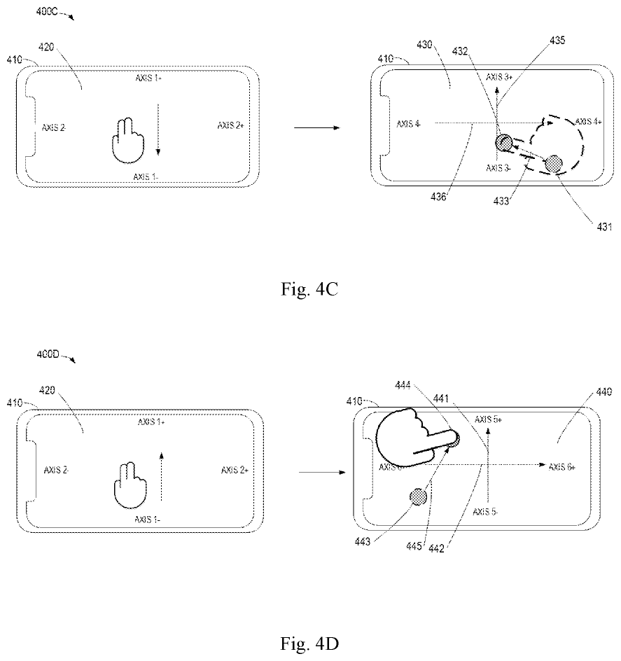

The jogging may be performed in three modes, such as a linear mode (may be referred to as a first mode), an axis/joint mode (may be referred to as a second mode) and a reorient mode (may be referred to as a third mode). In the linear mode, the robot may be instructed to move linearly towards an instructed direction in a selected coordinate system. Usually, the base coordinate system may be selected as default in the linear mode and the embodiment as illustrated in FIGS. 3A-3C may be referred to as jogging in the linear mode. In the axis/joint mode, the robot may be instructed to rotate the selected axes. In the reorient mode, the robot may be instructed to rotate around a reference point towards an instructed direction in a selected coordinate system. In some example embodiments, the terminal device may receive an input of gesture indicating a switch between modes. For example, the gesture may be a double swipe towards a predefined direction. Specific operations in the axis/joint mode will be described in detail with reference to FIGS. 4A-4D.

FIG. 4A schematically illustrates a schematic diagram of an example procedure 400A for controlling the robot axis by axis in accordance with some embodiments of the present disclosure. When the user wants to switch from one mode to another mode, the user may use two fingers to swipe on the current operating canvas. When the terminal device 410 receives the input of the swipe of double fingers, the terminal device 410 switches to another mode and converts the current canvas to a canvas used in the other mode.

As illustrated in FIG. 4A, the terminal device 410 renders a first canvas 402 as the current operating canvas which may be corresponding to the base coordinate system of the robot in a first mode (may referred to as “linear” mode). During the mode switching, when the terminal device 410 receives an input of a swipe of double fingers towards the Y-direction, the terminal device 410 switches to a second mode (may referred to as “axis” mode) for jogging the robot axis by axis. The robot may be corresponding to the robot 110 as illustrated in FIG. 1 which includes 6 axes. In the meantime, a new operating canvas 420 corresponding to the second mode is rendered on the screen. The canvas 420 includes a first coordinate axis 421 corresponding to an axis 1 of the robot and a second coordinate axis 422 corresponding to an axis 2 of the robot. A positive direction of the first coordinate axis 421 is marked with “AXIS 1+” and a negative direction of the first coordinate axis 421 is marked with “AXIS 1−”. Relatively, a positive direction of the second coordinate axis 422 is marked with “AXIS 2+” and a negative direction of the second coordinate axis 422 is marked with “AXIS 2−”. Specific operations performed on in the second mode will be described later in detail with reference to FIGS. 4B-4C.

FIG. 4B schematically illustrates a schematic diagram of an example procedure 400B for controlling the first two axes of the robot in accordance with some embodiments of the present disclosure. As illustrated in FIG. 4B, the user may use a finger to swipe on the canvas 420 to drive the axis 1 and axis 2 of the robot according to the swipe input. At the terminal device side, the terminal device 310 receives the input of the swipe on the current canvas 420. When the finger touches a first point 423 on the canvas 420, the terminal device 410 identifies an input of a touch on the first point 423. Then, the finger continues to move on the canvas 420 to a second point 424 and stops moving. The terminal device 410 identifies the input of the swipe as a vector 425 from a start point, i.e. the first point 423 to an end point, i.e. the second point 424.

After the vector 425 is determined, the terminal device 410 determines towards which one of the four directions (the direction AXIS 1+, the direction AXIS 1−, the direction AXIS 2+, and the direction AXIS 2−) the vector 425 is orientated. In the illustrated embodiment, the vector 425 is orientated towards the direction AXIS 1+. As a result, the terminal device 410 determines that the axis to be driven is the axis 1 and the rotation direction of axis 1 is the positive direction. Then, the terminal device 410 determines a length of the vector 425 and converts the length to a move speed of the axis for example according to a predefined ratio corresponding to the determined axis. With the obtained speed and direction information, the terminal device 410 generates a movement instruction. The terminal device 410 may transmit the movement instruction to a robot controller to cause the corresponding axis of the robot to rotate.

After completion of moving the robot with reference to axis 1 and 2, the user may want to move the robot with reference to other axes. In this case, the user may need to operate the terminal device 410 to change the canvas by an input of a trigger gesture. For example, the user may use two fingers to vertically swipe on the current operating canvas to cause the change of the canvas. As a result, when the terminal device 410 receives the input of the vertical swipe of double fingers, the terminal device 410 converts the current canvas to a canvas associated with other axes. Specific operations will be described with reference to FIGS. 4C and 4D.

FIG. 4C schematically illustrates a schematic diagram of an example procedure 400C for controlling next 2 axes of the robot in accordance with some embodiments of the present disclosure. As illustrated in FIG. 4C, the terminal device 410 renders the canvas 420 as the current operating canvas as default in this mode. During the canvas switching, when the terminal device 410 receives an input of a vertical swipe of double fingers towards the AXIS-direction, the terminal device 410 converts the canvas 420 to a new canvas 430.

The canvas 430 includes a third coordinate axis 435 corresponding to an axis 3 of the robot and a fourth coordinate axis 436 corresponding to an axis 4 of the robot. A positive direction of the third coordinate axis 435 is marked with “AXIS 3+” and a negative direction of the third coordinate axis 435 is marked with “AXIS 3−”. Relatively, a positive direction of the fourth coordinate axis 436 is marked with “AXIS 4+” and a negative direction of the fourth coordinate axis 436 is marked with “AXIS 4−”.

As illustrated, the user moves the finger on the point 431 to a point 432. At the terminal device side, the terminal device 410 receives the input of the swipe on the canvas 430 and identifies the input of the swipe as a vector 433 from a start point, i.e. the point 431 to an end point, i.e. the point 432 on the canvas 430. After the vector 433 is determined, the terminal device 410 determines towards which one of the four directions (the direction AXIS 3+, the direction AXIS 3−, the direction AXIS 4+, and the direction AXIS 4−) the vector 433 is orientated. In the illustrated embodiment, the vector 433 is determined to orientate towards the direction AXIS 4−. As a result, the terminal device 410 determines that the axis to be driven is the axis 4 and the rotation direction of axis 4 is the negative direction. Then, the terminal device 410 determines a length of the vector 433 and converts the length to a move speed of the axis according to a predefined ratio corresponding to the determined axis. With the obtained speed and direction information, the terminal device 410 generates a movement instruction. The terminal device 410 may transmit the movement instruction to a robot controller to cause the corresponding axis of the robot to rotate. When the operation on the canvas 430 is complete, the user may use two fingers to vertically swipe on the canvas 430 towards the AXIS 3+, i.e. vertically swipe up on the canvas 430 to cause the canvas 430 is converted back to the canvas 420.

FIG. 4D schematically illustrates a schematic diagram of an example procedure 400D for controlling the last 2 axes of the robot in accordance with some embodiments of the present disclosure. When the user moves or jogs the last 2 axes of the robot, the user need to operate the terminal device 410 to change the canvas 420 to a canvas 440 as the operating canvas by an input of a trigger gesture. In the illustrated embodiment, the user uses two fingers to vertically swipe on the canvas 420 towards the AXIS 1+. When the terminal device 410 receives an input of a vertical swipe of double fingers towards the AXIS+direction, the terminal device 410 converts the canvas 420 to a new canvas 430.

As illustrated in FIG. 4D, the terminal device 410 renders the canvas 440 as the current operating canvas. The canvas 440 includes a fifth coordinate axis 441 corresponding to an axis 5 of the robot and a sixth coordinate axis 446 corresponding to an axis 6 of the robot. A positive direction of the fifth coordinate axis 441 is marked with “AXIS 5+” and a negative direction of the fifth coordinate axis 441 is marked with “AXIS 5−”. Relatively, a positive direction of the sixth coordinate axis 442 is marked with “AXIS 6+” and a negative direction of the sixth coordinate axis 442 is marked with “AXIS 6−”.

As illustrated, the user moves the finger on the point 443 to a point 444. At the terminal device side, the terminal device 410 receives the input of the swipe on the canvas 440 and identifies the input of the swipe as a vector 445 from a start point, i.e. the point 443 to an end point, i.e. the point 444 on the canvas 430. After the vector 445 is determined, the terminal device 410 determines towards which one of the four directions (the direction AXIS 5+, the direction AXIS 5−, the direction AXIS 6+, and the direction AXIS 6−) the vector 445 is orientated. In the illustrated embodiment, the vector 445 is determined to orientate towards the direction AXIS 5+. As a result, the terminal device 410 determines that the axis to be driven is the axis 5 and the rotation direction of axis 5 is the positive direction. Then, the terminal device 410 determines a length of the vector 445 and converts the length to a move speed of the axis according to a predefined ratio corresponding to the determined axis. With the obtained speed and direction information, the terminal device 410 generates a movement instruction. The terminal device 410 may transmit the movement instruction to a robot controller to cause the corresponding axis of the robot to rotate.

When the operation on the canvas 440 is complete, the user may use two fingers to vertically swipe on the canvas 440 towards the AXIS 5−, i.e. vertically swipe down on the canvas 440 to cause the canvas 440 to be converted back to the canvas 420. In some alternative embodiments, the canvases may be changed sequentially when the user uses two fingers to continuously swipes on the screen in the same vertical direction. In some embodiments, the number of the axes may be more or less than 6. In these embodiments, the number of the canvases and related configurations can be modified adaptively without deviating from the embodiments of the present disclosure.

In this way, the jogging of robot axis by axis can be implemented with three canvases in combination with simple gestures inputs thereby reducing the operation complexity.

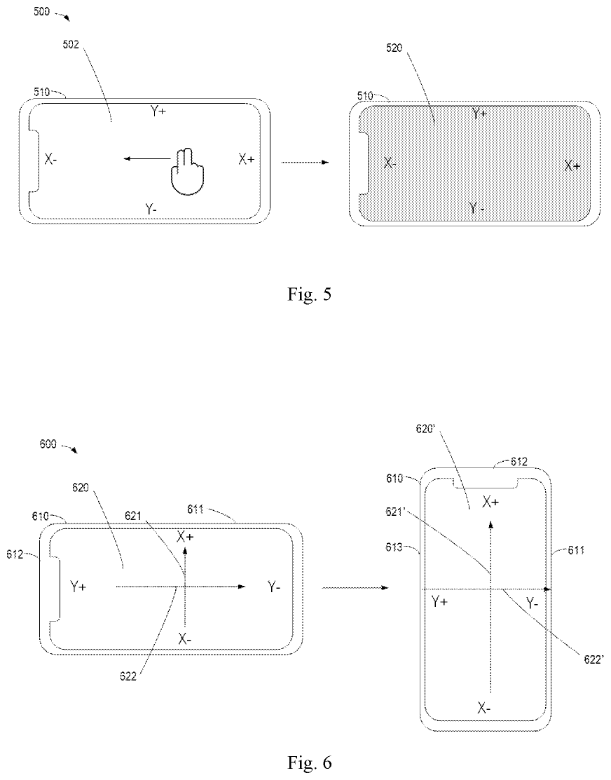

FIG. 5 schematically illustrates a schematic diagram of an example procedure 500 for switching to a third mode in accordance with some further embodiments of the present disclosure. As illustrated in FIG. 5, the terminal device 510 renders a first canvas 502 as the current operating canvas which may be corresponding to the base coordinate system of the robot. During the mode switching, when the terminal device 510 receives an input of a swipe of double fingers towards the Y+ direction, the terminal device 510 switches to a third mode (may referred to as “reorient” mode) for jogging the robot with reference to a tool coordinate system which may be corresponding to the tool coordinate system 143 as illustrated in FIG. 1. The robot may be corresponding to the robot 110 as illustrated in FIG. 1 which includes 6 axes. In the meantime, a new operating canvas 520 corresponding to the second mode is rendered on the screen. The canvas 520 is painted in a different color from the canvas 502 for distinction. In this embodiment, by painting different canvases from different modes with different colors, the user can be prompted.

The input gestures and their association with the directions in the selected coordinate system in the third mode are similar with those in the first mode which is illustrated in the FIGS. 3A-3C. A detailed description is omitted here to avoid redundancy.

It should be appreciated that although different input gestures are described in association with different modes, the trigger input gesture for changing canvas and input gesture for moving the robot can be applied to all the modes interchangeably.

FIG. 6 schematically illustrates a schematic diagram of an example procedure 600 for updating the coordinate in the canvas in accordance with some further embodiments of the present disclosure. As illustrated in FIG. 6, the terminal device 610 renders a canvas 620. The canvas 620 includes a first coordinate axis 621 corresponding to a dimension X of the base coordinate system and a second coordinate axis 622 corresponding to a dimension Y of the base coordinate system. A positive direction of the first coordinate axis 621 is marked with “X+” and a negative direction of the first coordinate axis 621 is marked with “X−”. Relatively, a positive direction of the second coordinate axis 622 is marked with “Y+” and a negative direction of the second coordinate axis 622 is marked with “Y−”.

As illustrated, when the user holds the terminal device 610 horizontally, the terminal device 610 may determine the current direction with reference to the user based on a motion information acquired from built-in motion sensors including Gyroscope and Accelerometer. The terminal device 610 renders the current canvas according to the current motion information. In this case, the first coordinate axis 621 is orientated towards a right edge 611 and the second coordinate axis 622 is orientated towards a top edge 612 of the terminal device 610.

In a case that the user tilts the terminal device 610 clockwise for 90 degrees, the terminal device 610 is held vertically. At this point, the terminal device 610 determines an orientation change of the terminal device 610 and changes the canvas 620 to a canvas 620′. The canvas 620′ includes a first coordinate axis 621′ corresponding to a dimension X of the base coordinate system and a second coordinate axis 622′ corresponding to a dimension Y of the base coordinate system. The first coordinate axis 621′ is orientated towards the top edge 612 and the second coordinate axis 622′ is orientated towards a left edge 613 of the terminal device 610.

In this embodiment, a mapping between the active robot coordinate system and the canvas directions will be established. The mapping shall be updated every time the mobile device is moved or rotated by the user. The built-in motion sensors could facilitate the monitoring of the movements of the terminal device. In this way, the user experience will be improved.

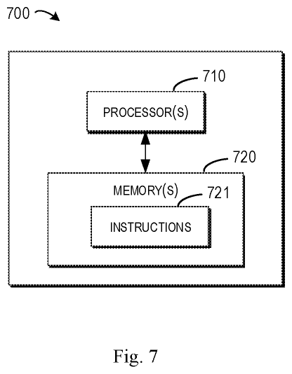

In some embodiments of the present disclosure, a computing device is provided for implementing the above methods 200A, 200B and 200C. FIG. 7 illustrates a schematic diagram of an electronic device 700 for implementing a method in accordance with embodiments of the present disclosure. The electronic device 700 may be corresponding to the terminal device 130 in FIG. 1, the terminal device 310 in FIGS. 3A-3C, the terminal device 410 in FIGS. 4A-4D, the terminal device 510 in FIG. 5 and the terminal device 610 in FIG. 6. The electronic device 700 comprises: at least one processor 710 and at least one memory 720. The at least one processor 710 may be coupled to the at least one memory 720. The at least one memory 720 comprises instructions 722 that when executed by the at least one processor 710 implements the methods 200, 220 or 300.

In some embodiments of the present disclosure, a computer readable medium for adjusting robot path is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A-6. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

It is to be understood that the summary section is not intended to identify key or essential features of embodiments of the present disclosure, nor is it intended to be used to limit the scope of the present disclosure. Other features of the present disclosure will become easily comprehensible through the following description.

1. A method for controlling a movement of a robot, comprising:
presenting one of a first canvas and a second canvas as an operating canvas on a screen of a terminal device, wherein the first canvas is associated with at least one dimension of the three dimensions of a first coordinate system of the robot, and the second canvas is associated with other one or more dimensions of the three dimensions;
receiving an input of a swipe on the operating canvas; and
generating a movement instruction for controlling the robot to move with reference to the first coordinate system based on the swipe.

2. The method of claim 1, wherein generating the move instruction comprises:
determining a number of dimensions associated with the operating canvas;
determining a vector corresponding to the swipe on the operating canvas;
determining a move direction of the robot with reference to the first coordinate system based on the number and a direction of the vector;
determining a move speed of the robot based on a length of the vector; and
generating the move instruction comprising the move direction and the move speed.

3. The method of claim 2, wherein determining the movement direction comprising:
in response to determining that the number of the dimensions is one, determining the one dimension is a first dimension;
determining that the operating canvas includes a first coordinate axis corresponding to the first dimension;
determining an inclined angle between the vector and the first coordinate axis; and
in response to determining an inclined angle is smaller than 90 degrees, determining the movement direction as a positive direction of the first dimension.

4. The method of claim 3, wherein determining the movement direction further comprises:
in response to determining the inclined angle is greater than 90 degrees, determining a negative direction of the first dimension as the movement direction.

5. The method of claim 2, wherein determining the movement direction comprises:
in response to determining that the number of the dimension is two, determining the dimensions comprises a second dimension and a third dimension;
determining that the first canvas includes a second coordinate axis and a third coordinate axis; and
determining the movement direction based on a direction of a vector corresponding to the swipe on the operating canvas and a mapping between the second coordinate axis and the second dimension and a mapping between the third coordinate axis and third dimension.

6. The method of claim 1, wherein receiving the input comprising:
presenting the first canvas;
converting the first canvas in the screen into the second canvas upon receiving a trigger input; and
receiving the input of the swipe on the second canvas.

7. The method of claim 6, wherein the trigger input comprises one of:
a circle on the first canvas;
double points on the first canvas; or
a point in a specific region.

8. The method of claim 7, wherein receiving the input of the swipe on the second canvas comprises:
receiving a first input on a first point in the second canvas;
receiving a second input on a second point in the second canvas during receiving the first input; and
receiving the swipe from the second input to a third point in the second canvas.

9. The method of claim 1, wherein the movement instruction is configured to cause the robot to move an incremental distance.

10. The method of claim 9, wherein further comprising:
recording a duration of the input after the movement instruction is generated;
determining that the duration passes a generation interval; and
generating another movement instruction.

11. The method of claim 9, further comprising:
receiving an input on a first region on the operation canvas for a predefined period;
increasing the movement increment, or
receiving an input on a second region on the operation canvas for a predefined period;
decreasing the movement increment.

12. The method of claim 1, further comprising:
receiving an input of a double swipe; and
in response to determining the double swipe is orientated towards a first direction of the screen, switching a first mode to a second mode,
wherein the first mode is configured to generate movement instructions for controlling a tool of the robot to movement with reference to the first coordinate system, and the second mode is configured to generate instructions for controlling the tool of the robot to movement with reference to a second coordinate system different from the first coordinate system.

13. The method of claim 12, further comprising:
in response to determining that the double swipe is orientated towards a second direction of the screen, switching the first mode to a third mode,
wherein the third mode is configured to generate instructions for controlling axes of the robot.

14. A electronic device comprising:
at least one processor; and
at least one memory storing instructions that, when executed by the at least one processor, cause the device to perform the method of claim 1.

15. A non-transitory computer readable storage medium storing instructions which, when executed by a computer, cause the computer to perform the method of claim 1.
